(19) United States
(12) Patent Application Publication
(10) Pub. No.: US 2014/0119339 A1
(43) Pub. Date: May 1, 2014

(54) METHOD FOR CONTROLLING ERROR FOR CARRIER AGGREGATION AND APPARATUS FOR SAME

(71) Applicants: Suckchel Yang, Anyang-si (KR); Mingyu Kim, Anyang-si (KR); Joonkui Ahn, Anyang-si (KR); Dongyoun Seo, Anyang-si (KR)

(72) Inventors: Suckchel Yang, Anyang-si (KR); Mingyu Kim, Anyang-si (KR); Joonkui Ahn, Anyang-si (KR); Dongyoun Seo, Anyang-si (KR)

(73) Assignee: LG ELECTRONICS INC., Seoul (KR)

(21) Appl. No.: 14/114,132

(22) PCT Filed: Apr. 23, 2012
(86) PCT No.: PCT/KR2012/003112

§ 371 Date: Dec. 18, 2013

Related U.S. Application Data
(60) Provisional application No. 61/478,558, filed on Apr. 25, 2011.
(60) Provisional application No. 61/510,495, filed on Jul. 22, 2011.

(51) Int. Cl. H04W 36/00

(52) U.S. Cl. CPC H04W 36/0072
USPC 370/331

(57) ABSTRACT

The present invention relates to a wireless communication system. More particularly, the present invention relates to a method for carrying out a hybrid automatic repeat request (HARQ) process when a plurality of cells are configured, comprising the following steps: receiving scheduling information for transmitting data from a first cell; operating a first HARQ process from the first cell based on the scheduling information; and relaying an operation of the first HARQ process to a second HARQ process of a second cell which is different from the first cell, when a predetermined condition is satisfied.

### TECHNICAL FIELD

The present invention relates to a wireless communication system, and more particularly, to a method of controlling an error for a carrier aggregation and an apparatus therefor.

### BACKGROUND ART

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may include one of CDMA (code division multiple access) system, FDMA (frequency division multiple access) system, TDMA (time division multiple access) system, OFDMA (orthogonal frequency division multiple access) system, SC-FDMA (single carrier frequency division multiple access) system and the like.

### DISCLOSURE OF THE INVENTION

### Technical Tasks

One object of the present invention is to provide a method of controlling an error in a wireless communication system and an apparatus therefor. Another object of the present invention is to provide a method of efficiently performing an error control in a carrier aggregation system and an apparatus therefor.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a method of performing a HARQ (hybrid automatic repeat request) process, by a user equipment configured of a plurality of cells in a wireless communication system includes the steps of receiving scheduling information to transmit data in a first cell, receiving scheduling information to transmit data in a first cell, and if a prescribed condition is satisfied, succeeding an operation of the first HARQ process to a second HARQ process of a second cell different from the first cell.

To further achieve these and other advantages and in accordance with the purpose of the present invention, according to a different embodiment, a user equipment configured to perform a HARQ (hybrid automatic repeat request) process in a state of configuring a plurality of cells in a wireless communication system includes a radio frequency (RF) unit and a processor, the processor configured to receive scheduling information to transmit data in a first cell, the processor configured to operate a first HARQ process in the first cell based on the scheduling information, if a prescribed condition is satisfied, the processor configured to succeed an operation of the first HARQ process to a second HARQ process of a second cell different from the first cell.

Preferably, the prescribed condition includes a conversion of the first cell converted from an activated state to a deactivated state before the first HARQ process is terminated.

Preferably, the prescribed condition includes reception of a DCI (downlink control information) format including carrier indication information indicating the first cell when the first cell is in a deactivated state.

Preferably, the DCI format is received via a third cell different from the first cell and detected in a PDCCH (physical downlink control channel) search space for the third cell in a subframe of the third cell.

Preferably, a second HARQ process of the second cell is determined based on HARQ process number indication information in the DCI format.

Preferably, a second HARQ process of the second cell is determined based on a subframe of which the DCI format is received.

### Advantageous Effects

According to the present invention, an error control can be efficiently performed in a wireless communication system. And, an error control can be efficiently performed in a carrier aggregation system.

Effects obtainable from the present invention may be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for explaining an example of physical channels used for 3GPP LTE system and a general signal transmission method using the same;

FIG. 2 is a diagram for explaining an example of a structure of a radio frame;

FIG. 3 is a diagram for one example of a resource grid for a downlink slot;

FIG. 4 is a diagram for a structure of a downlink subframe;

FIG. 5 is a diagram for a structure of an uplink subframe;

FIG. 6 is a diagram for an example of resource allocation and a retransmission process of an asynchronous DL HARQ (downlink hybrid automatic repeat request) scheme;

FIG. 7 is a diagram for an example of a synchronous UL HARQ (uplink hybrid automatic repeat request) process in case that UL-DL configuration #1 is set;

FIG. 8 is a diagram for an example of a carrier aggregation (CA) system;

FIG. 9 is a diagram for an example of a scheduling in case that a plurality of carriers are aggregated;

FIG. 10 is a diagram for an example that an SCC (or SCell) resource is allocated to a non-licensed band or a licensed band of a different system;

FIG. 11 and FIG. 12 are diagrams for examples of a HARQ process according to embodiment of the present invention;

FIG. 13 is a diagram for an example of a base station and a user equipment applicable to one embodiment of the present invention.

### BEST MODE

### Mode for Invention

The following description of embodiments of the present invention may apply to various wireless access systems including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. UTRA is a part of UMTS (Universal Mobile Telecommunications System). 3GPP (3rd Generation Partnership Project) LTE (long term evolution) is a part of E-UMTS (Evolved UMTS) that uses E-UTRA. 3GPP LTE adopts OFDMA in downlink and adopts SC-FDMA in uplink. LTE-A (LTE-Advanced) is an evolved version of 3GPP LTE.

For clarity, the following description mainly concerns 3GPP LTE system or 3GPP LTE-A system, by which the technical idea of the present invention may be non-limited. Specific terminologies used in the following description are provided to help understand the present invention and the use of the terminologies can be modified to a different form within a scope of the technical idea of the present invention.

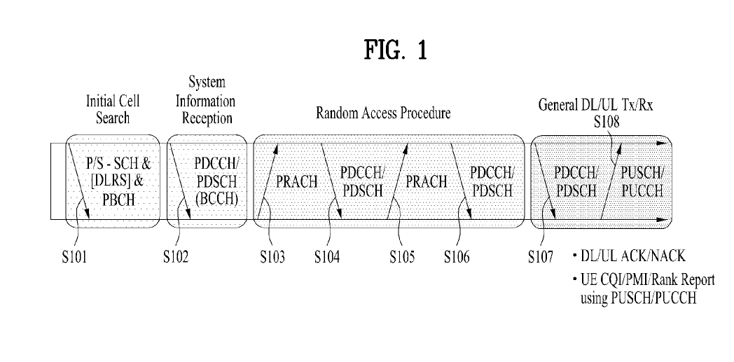

FIG. 1 is a diagram for explaining an example of physical channels used for 3GPP LTE system and a general signal transmission method using the same.

Referring to FIG. 1, if a power of a user equipment is turned on or the user equipment enters a new cell, the user equipment may perform an initial cell search job for matching synchronization with a base station and the like [S101]. To this end, the user equipment may receive a primary synchronization channel (P-SCH) and a secondary synchronization channel (S-SCH) from the base station, may match synchronization with the base station and may then obtain information such as a cell ID and the like. Subsequently, the user equipment may receive a physical broadcast channel (PBCH) from the base station and may be then able to obtain intra-cell broadcast information. Meanwhile, the user equipment may receive a downlink reference signal (DLRS) and may be then able to check a DL channel state.

Having completed the initial cell search, the user equipment may receive a physical downlink control channel (PDCCH) and a physical downlink shared control channel (PDSCH) according to the physical downlink control channel (PDCCH) and may be then able to obtain a detailed system information [S102].

Meanwhile, the user equipment may be able to perform a random access procedure to complete the access to the base station [S103 to S106]. To this end, the user equipment may transmit a preamble via a physical random access channel (PRACH) [S103] and may be then able to receive a response message via PDCCH and a corresponding PDSCH in response to the preamble [S104]. In case of a contention based random access, it may be able to perform a contention resolution procedure such as a transmission [S105] of an additional physical random access channel and a channel reception [S106] of a physical downlink control channel and a corresponding physical downlink shared channel.

Having performed the above mentioned procedures, the user equipment may be able to perform a PDCCH/PDSCH reception [S107] and a PUSCH/PUCCH (physical uplink shared channel/physical uplink control channel) transmission [S108] as a general uplink/downlink signal transmission procedure. Control information transmitted to a base station by a user equipment may be commonly named uplink control information (hereinafter abbreviated UCI). The UCI may include HARQ-ACK/NACK (Hybrid Automatic Repeat and reQuest Acknowledgement/Negative-ACK), SR (Scheduling Request), CQI (Channel Quality Indication), PMI (Precoding Matrix Indication), RI (Rank Indication) and the like. In the present specification, the HARQ-ACK/NACK is simply called HARQ-ACK or ACK (NACK) (A/N). The HARQ-ACK includes at least one of a positive ACK (simply, ACK), a negative ACK (NACK), DTX, and NACK/DTX. The UCI is normally transmitted via PUCCH by periods. Yet, in case that both control information and traffic data need to be simultaneously transmitted, the UCI may be transmitted on PUSCH. Moreover, the UCI may be non-periodically transmitted in response to a request/indication made by a network.

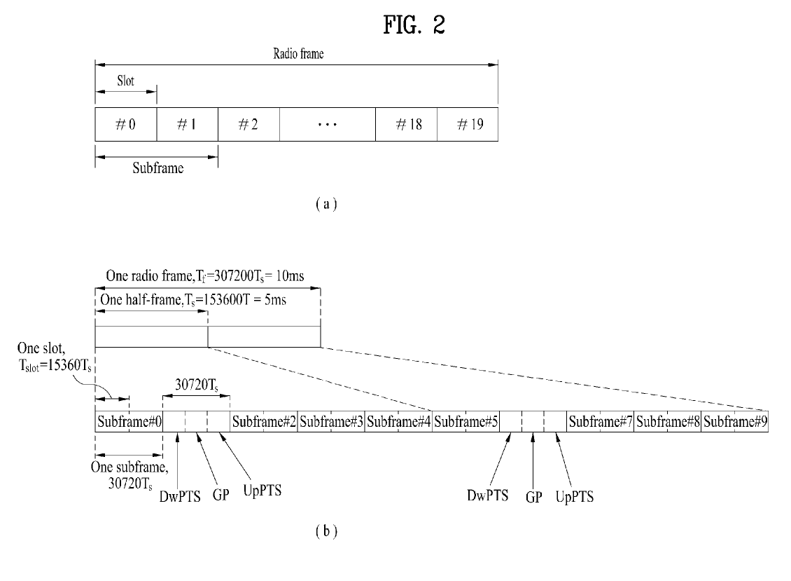

FIG. 2 is a diagram for explaining an example of a structure of a radio frame. Referring to FIG. 2, UL/DL (uplink/downlink) data packet transmission is performed by a unit of subframe in a cellular OFDM radio packet communication system. And, one subframe is defined as a predetermined time interval including a plurality of OFDM symbols. In the 3GPP LTE standard, a type-1 radio frame structure applicable to FDD (frequency division duplex) and a type-2 radio frame structure applicable to TDD (time division duplex) are supported.

FIG. 2(a) is a diagram for a structure of a type 1 radio frame. A DL (downlink) radio frame includes 10 subframes. Each of the subframes includes 2 slots in time domain. And, a time taken to transmit one subframe is defined as a transmission time interval (hereinafter abbreviated TTI). For instance, one subframe may have a length of 1 ms and one slot may have a length of 0.5 ms. One slot may include a plurality of OFDM symbols in time domain and may include a plurality of resource blocks (RBs) in frequency domain. Since 3GPP LTE system uses OFDM in downlink, OFDM symbol is provided to indicate one symbol period. The OFDM symbol may be named SC-FDMA symbol or symbol period. Resource block (RB) may include a plurality of contiguous subcarriers in one slot.

The number of OFDM symbols included in one slot may vary in accordance with a configuration of CP. The CP may be categorized into an extended CP and a normal CP. For instance, in case that OFDM symbols are configured by the normal CP, the number of OFDM symbols included in one slot may be 7. In case that OFDM symbols are configured by the extended CP, since a length of one OFDM symbol increases, the number of OFDM symbols included in one slot may be smaller than that of the case of the normal CP. In case of the extended CP, for instance, the number of OFDM symbols included in one slot may be 6. If a channel status is unstable (e.g., a UE is moving at high speed), it may be able to use the extended CP to further reduce the inter-symbol interference.

When a normal CP is used, since one slot includes 7 OFDM symbols, one subframe includes 14 OFDM symbols. In this case, first maximum 3 OFDM symbols of each subframe may be allocated to PDCCH (physical downlink control channel), while the rest of the OFDM symbols are allocated to PDSCH (physical downlink shared channel).

FIG. 2(b) is a diagram for an example of a structure of a type 2 radio frame. The type-2 radio frame includes 2 half frames. Each of the half frames includes 5 subframes, DwPTS (downlink pilot time slot), GP (guard period) and UpPTS (uplink pilot time slot) and one subframe consists of two slots. The DwPTS is used for initial cell search, synchronization or channel estimation in a user equipment. The UpPTS is used for channel estimation in a base station and uplink transmission synchronization of a user equipment. The guard period is a period for eliminating interference generated in uplink due to multi-path delay of a downlink signal between uplink and downlink.

The above-described structures of the radio frame are exemplary only. And, the number of subframes included in a radio frame, the number of slots included in the subframe and the number of symbols included in the slot may be modified in various ways.

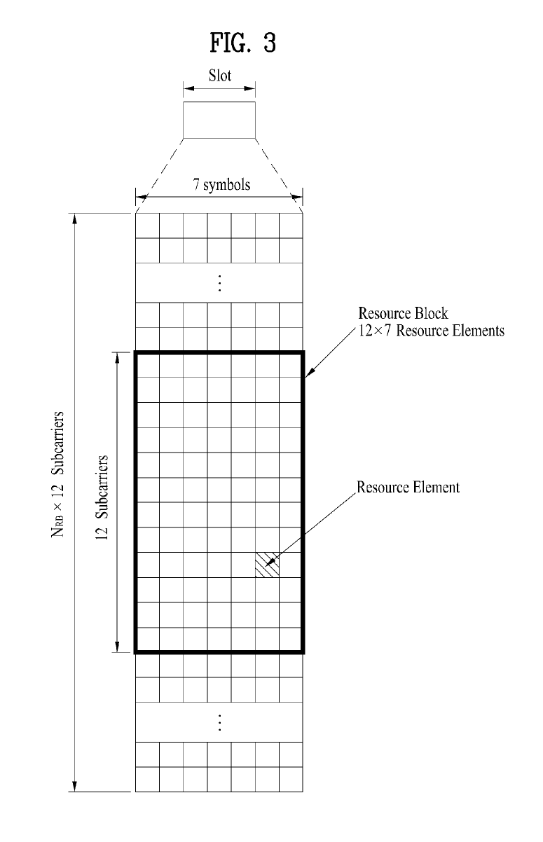

FIG. 3 is a diagram for one example of a resource grid for a downlink slot. Referring to FIG. 3, one downlink (DL) slot may include a plurality of OFDM symbols in time domain. In particular, one DL slot exemplarily includes 7(6) OFDM symbols and one resource block (RB) includes 12 subcarriers in frequency domain. Each element on a resource grid is called a resource element (hereinafter abbreviated RE). One resource block includes 12×7(6) resource elements. The number N_{RB} of resource blocks included in a DL slot may depend on a DL transmission bandwidth. And, the structure of an uplink (UL) slot may be identical to that of the DL slot and OFDM symbol is replaced by SC-FDMA symbol.

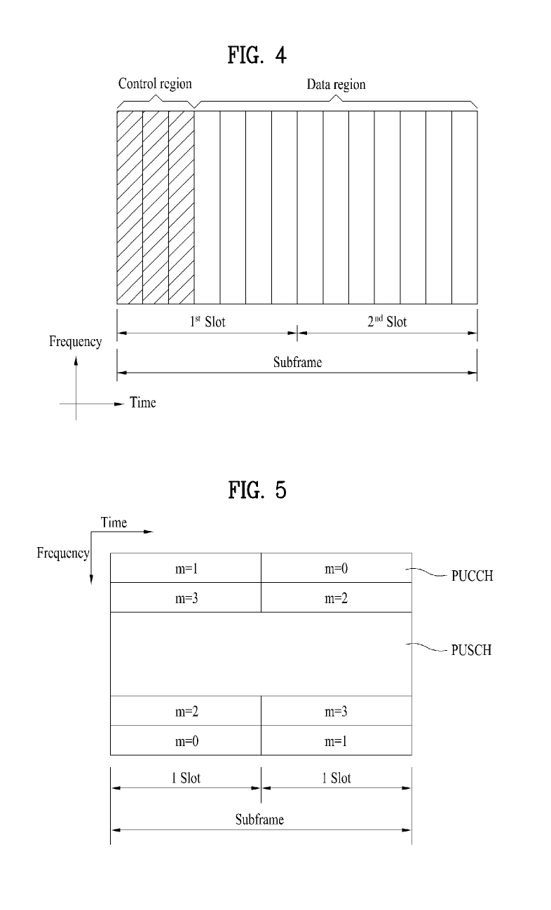

FIG. 4 is a diagram for an example of a structure of a downlink subframe.

Referring to FIG. 4, maximum 3 (4) OFDM symbols situated at a fore part of a first slot of one subframe correspond to a control region to which control channels are allocated. The rest of OFDM symbols correspond to a data region to which PDSCH (physical downlink shared channel) is allocated. PDSCH is used for carrying a transport block (hereinafter abbreviated TB) or a codeword (hereinafter abbreviated CW) corresponding to the TB. The TB means a data block delivered from a MAC (medium access control) layer to a PHY (physical) layer on a transport channel. The CW corresponds to a coded version of the TB. Correlation between the TB and the CW may vary depending on a swapping. In the present specification, PDSCH, a TB, and a CW are used in a manner of being mixed. Examples of DL control channels used by LTE (-A) may include PCFICH (Physical Control Format Indicator Channel), PDCCH (Physical Downlink Control Channel), PHICH (Physical hybrid automatic repeat request indicator Channel) and the like. The PCFICH is transmitted in a first OFDM symbol of a subframe and carries information on the number of OFDM symbols used for a transmission of a control channel within the subframe. The PHICH carries a HARQ-ACK (hybrid automatic repeat and request acknowledgement) signal in response to an UL transmission. The HARQ-ACK response includes a positive ACK (simply, ACK), a negative ACK (NACK), DTX (discontinuous transmission), or NACK/DTX. In this case, HARQ-ACK, HARQ ACK/NACK, and ACK/NACK are used in a manner of being mixed.

Control information carried on PDCCH may be called downlink control information (hereinafter abbreviated DCI). The DCI includes resource allocation information for a UE or a UE group and different control information. For instance, the DCI includes UL/DL scheduling information, UL transmit (Tx) power control command, and the like. Transmission mode for configuring a multi antenna technique and information content of a DCI format are described in the following.

Transmission Mode (TM)
Transmission mode 1: Transmission from a single base station antenna port
Transmission mode 2: Transmit diversity
Transmission mode 3: Open-loop spatial multiplexing
Transmission mode 4: Closed-loop spatial multiplexing
Transmission mode 5: Multi-user MIMO (Multiple Input Multiple Output)
Transmission mode 6: Closed-loop rank-1 precoding
Transmission mode 7: Transmission using UE-specific reference signals

DCI Format
format 0: Resource grants for the PUSCH(Physical Uplink Shared Channel) transmissions (uplink)
format 1: Resource assignments for single codeword PDSCH(Physical Downlink Shared Channel) transmissions (transmission modes 1, 2 and 7)
format 1A: Compact signaling of resource assignments for single codeword PDSCH (all modes)
format 1B: Compact resource assignments for PDSCH using rank-1 closed loop precoding (mode 6)
format 1C: Very compact resource assignments for PDSCH (e.g. paging/broadcast system information)
format 1D: Compact resource assignments for PDSCH using multi-user MIMO (mode 5)
format 2: Resource assignments for PDSCH for closed-loop MIMO operation (mode 4)
format 2A: Resource assignments for PDSCH for open-loop MIMO operation (mode 3)
format 3/3A: Power control commands for PUCCH(Physical Uplink Control Channel) and PUSCH with 2-bit/1-bit power adjustments

As mentioned in the foregoing description, PDCCH carries a transmission format and resource allocation information of DL-SCH (downlink shared channel), a transmission format and resource allocation information of UL-SCH (uplink shared channel), paging information on a PCH (paging channel), system information on a DL-SCH, resource allocation information of an upper layer control message such as a random access response transmitted on PDSCH, a transmit (Tx) power control command set for an individual user equipments within a user equipment (UE) group, a transmit (Tx) power control command, information on activation indication of VoIP (voice over IP), and the like. A plurality of PDCCHs can be transmitted in a control region and a user equipment is able to monitor a plurality of the PDCCHs. PDCCH is configured with the aggregation of at least one or more contiguous CCEs (control channel elements). CCE is a logical assignment unit used to provide PDCCH with a code rate in accordance with a state of a radio channel. CCE corresponds to a plurality of REGs (resource element groups). A format of PDCCH and the number of bits of an available PDCCH are determined according to the number of CCEs. A base station determines a PDCCH format in accordance with DCI to be transmitted to a user equipment and attaches a CRC (cyclic redundancy check) to control information. The CRC is masked with a unique identifier (e.g., RNTI (radio network temporary identifier)) in accordance with an owner or usage of PDCCH. If PDCCH is provided for a specific user equipment, the CRC can be masked with a unique identifier of the corresponding user equipment, i.e., C-RNTI (i.e., Cell-RNTI). If PDCCH is provided for a paging message, the CRC can be masked with a paging identifier (e.g., P-RNTI (Paging-RNTI)). If PDCCH is provided for system information, and more particularly, for a system information block (SIB), the CRC can be masked with a system information identifier (e.g., SI-RNTI (system information-RNTI). If PDCCH is provided for a random access response, the CRC can be masked with RA-RNTI (random access-RNTI).

FIG. 5 is a diagram for an example of a structure of an uplink subframe.

Referring to FIG. 5, an uplink subframe includes a plurality of slots (e.g., 2 slots). A slot may include a different number of SC-FDMA symbols according to a length of CP. A UL subframe may be divided into a control region and a data region in frequency domain. The data region includes PUSCH and can be used for transmitting a data signal such as an audio and the like. The control region includes PUCCH and can be used for transmitting UL control information (UCI). The PUCCH includes a RB pair situated at the both ends of the data region on a frequency axis and hops on a slot boundary.

The PUCCH can be used for transmitting following control information.
SR (scheduling request): information used for making a request for an uplink UL-SCH resource. This information is transmitted using an OOK (on-off keying) scheme.
HARQ-ACK: a response signal for a downlink data packet (e.g., a codeword) on PDSCH. This information indicates whether the downlink data packet is successfully received. HARQ ACK 1 bit is transmitted in response to a single downlink codeword (CW) and HARQ ACK 2 bits are transmitted in response to two downlink codewords.
CSI (channel state information): feedback information on a downlink channel. MIMO (multiple input multiple output)-related feedback information includes an RI (rank indicator) and a PMI (precoding matrix indicator). 20 bits per subframe are used for this information.

An amount of control information capable of being transmitted by a UE in a subframe depends on the number of SC-FDMA symbol available for transmitting the control information. The SC-FDMA available for transmitting the control information means a remaining SC-FDMA symbol except an SC-FDMA symbol used for transmitting a reference signal (RS) in a subframe. In case of a subframe to which an SRS (sounding reference signal) is configured thereto, a last SC-FDMA symbol of the subframe is excluded as well. A reference signal is used to detect coherent of PUCCH. PUCCH supports various formats depending on transmitted information.

Table 1 indicates a mapping relation between a PUCCH format and a UCI in LTE (-A).

TABLE 1

| PUCCH format | UL control information (UCI) |
|---|---|
| Format 1 | SR (scheduling request) (un-modulated wave) |
| Format 1a | 1-bit HARQ ACK/NACK (SR existence/non-existence) |
| Format 1b | 2-bit HARQ ACK/NACK (SR existence/non-existence) |
| Format 2 | CSI (20 coded bits) |
| Format 2 | CSI and 1- or 2-bit HARQ ACK/NACK (20 bits) |
| | (only applied to extended CP) |
| Format 2a | CSI and 1-bit HARQ ACK/NACK (20 + 1 coded bits) |
| Format 2b | CSI and 2-bit HARQ ACK/NACK (20 + 2 coded bits) |
| Format 3 | Maximum 24 bits HARQ ACK/NACK + SR |
| (LTE-A) | |

In the following description, a method of controlling an error is described. A base station schedules one or more resource blocks for a user equipment selected according to a determined scheduling rule in DL and then the base station transmits data to the corresponding user equipment using the allocated resource block. The base station schedules one or more resource blocks for the user equipment selected according to a determined scheduling rule in UL and then the user equipment transmits data in UL using the allocated resource. As a method of controlling an error for a data transmission, there exist an ARQ (automatic repeat request) scheme and a HARQ (hybrid ARQ) scheme as a more enhanced form. Both the ARQ scheme and the HARQ scheme transmit data (e.g., transport block or codeword) and then wait for a confirmation signal (ACK). A receiving end sends the confirmation signal (ACK) only when data is successfully received. If there is an error in the received data, the receiving end sends a NACK (negative-ACK) signal. A transmitting end transmits data after the ACK signal is received. If the NACK signal is received, the transmitting end retransmits the data. If an error data occurs, the ARQ scheme and the HARQ scheme differently process the error data. In case of the ARQ scheme, the error data is deleted from a buffer of the receiving end and the error data is not used in the following process. On the other hand, in case of the HARQ scheme, the error data is stored in a HARQ buffer and then combined with a following retransmission data to increase reception success rate.

In case of a 3GPP system, an RLC (radio link control) layer performs an error control using the ARQ scheme and a MAC (medium access control)/PHY (physical) layer perform the error control using the HARQ scheme. The HARQ scheme is classified into a synchronous HARQ and an asynchronous HARQ according to retransmission timing. Or, the HARQ scheme may be classified into a channel-adaptive HARQ and a channel-non-adaptive HARQ according to whether a channel state is considered to determine an amount of retransmission resource.

The synchronous HARQ is a scheme performing a following retransmission on a timing point determined by a system in case that an initial transmission has failed. For instance, if it is assumed that a retransmission is performed at every N^{th} (e.g., N=4) time unit (e.g., TTI, subframe) after the initial transmission has failed, a base station and a user equipment do not need to exchange information on a retransmission timing with each other. Hence, if an NACK message is received, the transmitting end can retransmit corresponding data on every 4^{th} time unit until an ACK message is received. On the other hand, according to the asynchronous HARQ scheme, the retransmission timing is newly scheduled or achieved by an additional signaling. In particular, the retransmission timing for an error data may vary according to such various factors as a channel state and the like.

The channel-non-adaptive HARQ scheme is a scheme that an MCS (modulation and coding scheme), the number of resource blocks, and the like for a retransmission are determined when an initial transmission is performed. Unlike the channel-non-adaptive HARQ scheme, the channel-adaptive HARQ scheme is a scheme that the MCS (modulation and coding scheme), the number of resource blocks, and the like for a retransmission vary according to a channel state. For instance, in case of the channel-non-adaptive HARQ scheme, if an initial transmission is performed using 6 resource blocks, a retransmission is performed using 6 resource blocks. On the other hand, in case of the channel-adaptive HARQ scheme, although the initial transmission is performed using 6 resource blocks, the retransmission can be performed using resource blocks greater or less than 6 according to a channel state.

According to the aforementioned classification, 4 types of HARQ combination can be made. Yet, two types of combination, i.e., an asynchronous/channel-adaptive HARQ scheme and a synchronous/channel-non-adaptive HARQ scheme are mainly used. The asynchronous/channel-adaptive HARQ scheme can maximize retransmission efficiency by adaptively differentiating retransmission timing and an amount of retransmission resource according to a channel state. Yet, this scheme has a drawback of a significant overhead. Hence, this scheme is not considered for UL in general. Meanwhile, according to the synchronous/channel-non-adaptive HARQ scheme, since timing for a retransmission and resource allocation are already promised in a system, there is little overhead. Yet, if this scheme is used in an unstable channel, this scheme has a drawback of very low retransmission efficiency. Currently, the asynchronous HARQ scheme is used for DL and the synchronous HARQ scheme is used for DL in 3GPP LTE.

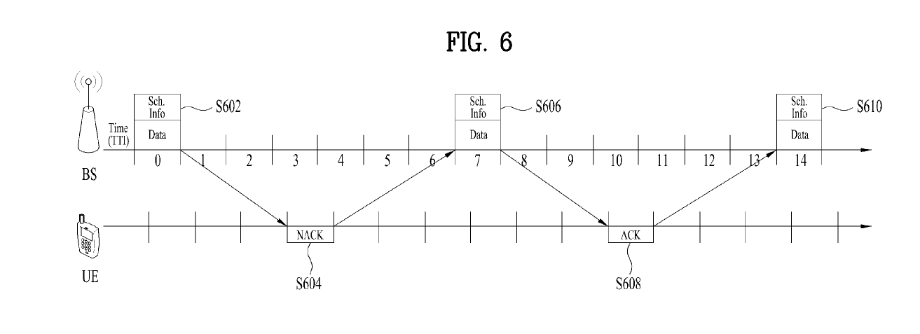

FIG. 6 is a diagram for an example of resource allocation and a retransmission process of an asynchronous DL HARQ (downlink hybrid automatic repeat request) scheme.

Referring to FIG. 6, a base station transmits scheduling information (Sch. Info)/data (transport block or codeword) to a user equipment [S602] and then waits for a reception of ACK/NACK from the user equipment. If NACK is received from the user equipment [S604], the base station retransmits scheduling information/data to the user equipment [S606] and then waits for a reception of ACK/NACK from the user equipment. If ACK is received from the user equipment [S608], a HARQ process is terminated. Later, if a new data transmission is required, the base station can transmit scheduling information on the new data and the corresponding data to the user equipment [S610].

Meanwhile, referring to FIG. 6, after transmitting the scheduling information/data [S602], a time delay occurs until the base station receives the ACK/NACK and the retransmission data is transmitted. The time delay occurs due to a channel propagation delay and time taken for performing data decoding/encoding. Hence, in case of transmitting a new data after a currently proceeding HARQ process is finished, a gap occurs in transmitting a data due to the time delay. Hence, in order to reduce the gap during a time delay interval, a plurality of independent HARQ processes can be used. For instance, if a space between an initial transmission and a retransmission corresponds to 7 subframes, data transmission can be performed without any gap in a manner of managing 7 independent HARQ processes. A plurality of parallel HARQ processes make UL/DL transmission to be contiguously performed while waiting for a HARQ feedback for a previous UL/DL transmission. Each of a plurality of the HARQ processes relates to a HARQ buffer of an MAC (medium access control) layer. Each of a plurality of the HARQ processes manages state variables regarding the number of transmission of MAC PDU (physical data block) within a buffer, a HARQ feedback for the MAC PDU within a buffer, a current redundancy version, and the like.

Specifically, in case of an LTE (-A) FDD, if it is not operated in MIMO (multiple input multiple output), maximum 8 HARQ processes are assigned. Meanwhile, in case of an LTE (-A) TDD, the number of UL HARQ process varies according to a UL-DL configuration.

Table 2 indicates the number of a synchronous UL HARQ process in TDD.

TABLE 2

| | Number of HARQ | Number of HARQ |
|---|---|---|
| TDD UL-DL | processes for normal | processes for subframe |
| configuration | HARQ operation | bundling operation |
| 0 | 7 | 3 |
| 1 | 4 | 2 |
| 2 | 2 | N/A |
| 3 | 3 | N/A |
| 4 | 2 | N/A |
| 5 | 1 | N/A |
| 6 | 6 | 3 |

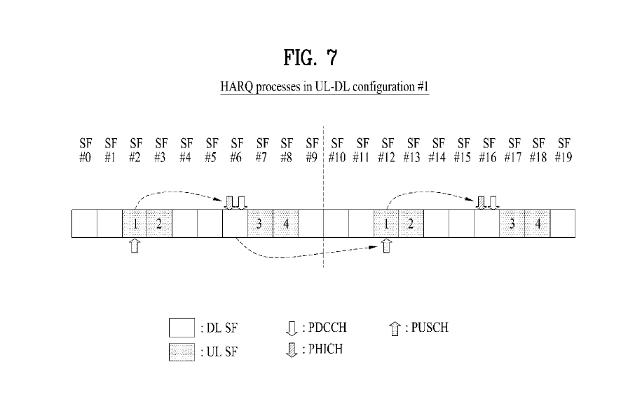

FIG. 7 is a diagram for an example of a synchronous UL HARQ (uplink hybrid automatic repeat request) process in case that UL-DL configuration #1 is configured. The numbers in boxes exemplify UL HARQ process numbers. The present example indicates a normal UL HARQ process. Referring to FIG. 7, a HARQ process #1 relates to an SF #2, an SF #6, an SF #12, and an SF #16. For instance, if an initial PUSCH signal (e.g., RV=0) is transmitted in the SF #2, a corresponding UL grant PDCCH and/or PHICH is received in the SF #6 and a corresponding (retransmission) PUSCH signal (e.g., RV=2) can be transmitted in the SF #12. Hence, in case of the UL-DL configuration #1, there exist 4 UL HARQ processes where RTT (round trip time) corresponds to 10 SFs (or 10 ms).

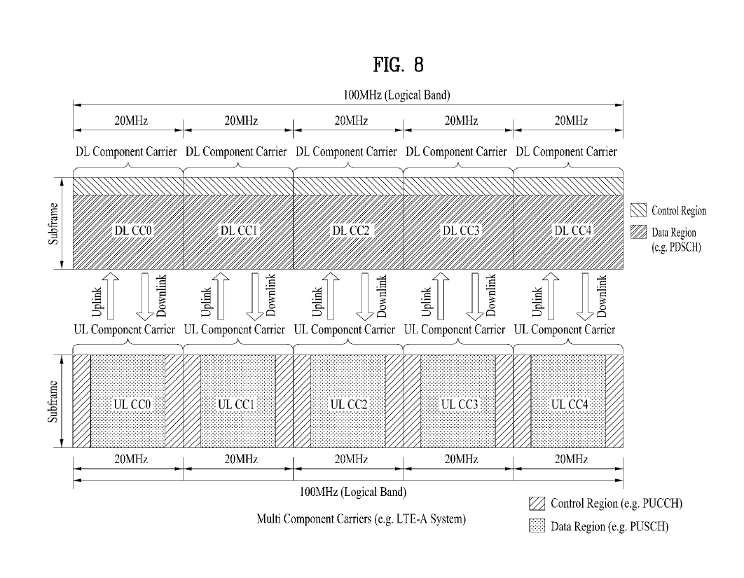

FIG. 8 is a diagram for an example of a carrier aggregation (CA) system. LTE-A system uses a carrier aggregation (or bandwidth aggregation) technique using a wider UL/DL bandwidth in a manner of collecting a plurality of UL/DL frequency bandwidths to use a wider frequency bandwidth. Each frequency block is transmitted using a component carrier (CC). The component carrier can be comprehended as a carrier frequency (or, a center carrier, a center frequency) for the corresponding frequency block.

Referring to FIG. 8, it is able to support a wider UL/DL bandwidth in a manner of collecting a plurality of UL/DL component carriers. Each of the component carriers can be contiguous or non-contiguous with each other in frequency domain. The bandwidth of each CC can be individually determined It is possible to perform an asymmetrical carrier aggregation, which means that the number of DL CC and the number of UL CC are different from each other. For instance, in case that there exist 2 DL CCs and 1 UL CC, it may be possible to configure a DL-UL linkage corresponding to DL CC:UL CC=2:1. A DL CC/UL CC link can be configured to be fixed in a system or to be semi-static. Although a whole bandwidth of a system is configured with N number of CCs, a frequency band capable of being monitored/received by a specific user equipment can be limited to M (<N) number of CCs. Various parameters for a carrier aggregation can be configured cell-specifically, UE group-specifically, or UE-specifically. Meanwhile, control information can be configured to be transceived on a specific channel only. For instance, a DL control channel performing a transmission of system and common control information and a UL control channel performing a UCI transmission of ACK/NACK for DL data, CSI, and the like can be configured to be transceived on a specific CC only. The specific CC is called a primary CC (PCC) and the rest of CCs can be called a secondary CC (SCC).

LTE-A uses a concept of a cell to manage a radio resource. A cell is defined as a combination of a DL and UL resource and the UL resource is not a mandatory element. Hence, a cell can be configured with the DL resource alone or can be configured with the DL resource and the UL resource together. If a carrier aggregation is supported, a linkage between a carrier frequency of the DL resource (or, DL CC) and a carrier frequency of the UL resource (or, UL CC) can be indicated by system information. A cell operating on a primary frequency (or, PCC) is called a primary cell (Pcell) and a cell operating on a secondary frequency (or, SCC) is called a secondary cell (Scell). The Pcell is used for a user equipment to perform an initial connection establishment process or a connection re-establishment process. The PCell may correspond to a cell operating on a DL CC, which is SIB 2 linked to a UL CC to which a control signal is transmitted thereto. And, the PCell may correspond to a cell indicated in a handover process. The SCell can be configured after an RRC (radio resource control) connection is established and can be used to provide an additional radio resource. Both the Pcell and the Scell can be commonly called a serving cell. Hence, in case of a user equipment not configured with a carrier aggregation while staying in a state of RRC_CONNECTED or a user equipment not supporting a carrier aggregation, there exists only one serving cell configured with the Pcell only. On the contrary, in case of a user equipment configured with the carrier aggregation and staying in a state of RRC_CONNECTED, there exists one or more serving cells. And, the Pcell and the total of the Scells are included in the total serving cells. For the carrier aggregation, after an initial security activation process has started, a network may be able to configure one or more Scells for a carrier aggregation supportive user equipment in addition to the Pcell, which is initially configured in the connection establishment process.

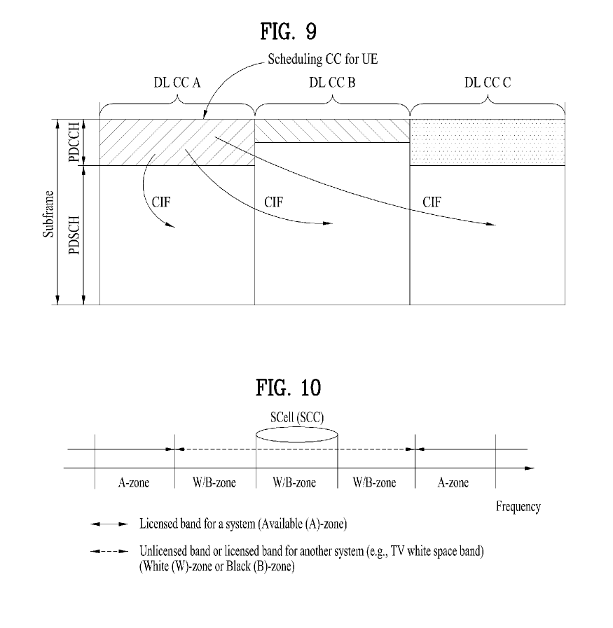

FIG. 9 is a diagram for an example of a scheduling in case that a plurality of carriers are aggregated. Assume that 3 DL CCs are aggregated. Assume that a DL CC A is configured as a PDCCH CC. The DL CC A, a DL CC B, and a DL CC C can be called a serving CC, a serving carrier, a serving cell, or the like. If a CIF (carrier indicator field) is disabled, each of the DL CCs may be able to transmit PDCCH only, which schedules PDSCH of each of the DL CCs, according to an LTE PDCCH rule without the CIF (non-cross-CC scheduling). On the other hand, if the CIF is enabled by a UE-specific (or UE group-specific or cell-specific) upper layer signaling, a specific CC (e.g., DL CC A) can transmit not only PDCCH scheduling PDSCH of the DL CC A but also PDCCH scheduling PDSCH of a different CC using the CIF (cross-CC scheduling). Yet, PDCCH is not transmitted on the DL CC B and the DL CC C.

In case of the cross-CC scheduling, it is able to configure DL/UL grant PDCCH required for scheduling DL/UL data transceived on a specific CC (i.e., SCC) and ACK/NACK information on UL data to be transceived on the specific CC only. The specific CC (or cell) is called a scheduling CC (or cell) or a monitoring CC (MCC) (or cell). On the contrary, a CC of which PDSCH/PUSCH is scheduled by PDCCH of a different CC is called a scheduled CC (or cell). One or more MCCs can be configured for a UE. The MCC includes a PCC. If there is one scheduling CC, the scheduling CC may be equivalent to the PCC. For clarity, assume that the MCC (e.g., PCC) and the SCC are in the cross-CC scheduling relation in the present specification. One or more SCCs can be configured to have a cross-CC scheduling relation with a specific MCC in the present specification.

Currently, in case that the cross-CC scheduling is configured, a CC carrying a signal is defined as follows according to a type of the signal.
PDCCH (UL/DL grant): MCC
PDSCH/PUSCH: a CC indicated by a CIF of PDCCH detected on MCC
DL ACK/NACK (PHICH): MCC (e.g., DL PCC)
UCI (e.g., UL ACK/NACK) (PUCCH): UL PCC

Subsequently, a method of configuring an SCC (or SCell) resource is explained. Basically, a communication system performs a communication using a licensed band of the communication system. Yet, as lack of a frequency resource is recently intensified, a discussion for efficiently utilizing the frequency resource has been received lots of attentions. As one of the discussion, there is a discussion for performing a communication in a manner of borrowing a part of resource from a non-licensed band or a licensed band of a different system. For instance, a PCC/MCC is assigned to an LTE-A licensed band and an SCC can be assigned to a non-licensed band or a licensed band of a different system.

FIG. 10 depicts an example that an SCC (or SCell) resource is allocated to a non-licensed band or a licensed band of a different system. Referring to FIG. 10, an SCC can be assigned to an available (i.e., not occupied by a different system) specific frequency domain in a non-licensed band or an available (i.e., not used by a licensed user) specific frequency domain in a specific licensed band (e.g., TV white space band). The available frequency band in the non-licensed band can be obtained by a carrier-sensing process. And, the available frequency band in the specific licensed band can be obtained by a database search for the use of a licensed user of a corresponding system. For instance, a base station makes a request for information on a channel use to a database management server and the database management server can inform the base station of a state of the channel use. For clarity, a frequency band available for a 3GPP system is called a W-zone (white-zone) and a frequency band unavailable for the 3GPP system is called a B-zone (black-zone) among a non-licensed band and a licensed band of a different system.

As mentioned in the foregoing description, a base station can measure/recognize information on the W-zone and the B-zone within a CA target band via a carrier-sensing or a database. The W-zone/B-zone can vary depending on a user state and the like of a corresponding system. Hence, as a method of managing an SCC resource, the base station can change whether an SCC is activated or not by performing the carrier-sensing or a database search process. For instance, if a specific frequency domain is recognized as the W-zone, the base station can transmit/receive a DL/UL data in a manner of assigning the corresponding frequency band as an SCC. Yet, if the corresponding frequency band is identified as the B-zone in a following process, the base station can deactivate the corresponding SCC to avoid interference affecting a different system or a licensed user. And, if the corresponding frequency band is identified as the W-zone again in a following process, the base station can repeat a process of performing the DL/UL data transmission/reception by activating the corresponding SCC again.

As a different method of managing the SCC resource, a base station/user equipment performs (i.e., activates) a DL/UL data transmission/reception for a specific time duration only via an SCC of a W-zone state and may be then able to automatically deactivate the corresponding SCC. Subsequently, if the corresponding SCC is recognized as the W-zone on a specific timing point by performing a carrier-sensing or a database search, a base station can repeat a process of performing the DL/UL data transmission/reception in a manner of activating the corresponding SCC again for specific time duration only. To this end, the base station can transmit PDCCH indicating SCC activation for a specific SCC and the PDCCH can include DL/UL grant information on the corresponding SCC. In this case, the base station/user equipment maintains the activated state of the corresponding SCC for specific time duration only and may be then able to automatically deactivate the corresponding SCC.

Meanwhile, (due to a competition with a different system or a long time occupation of a licensed user), it is able to consider a situation that an SCC-deactivated duration is assigned as relatively long and an SCC-activated duration is assigned as relatively short (e.g., less than 8 ms). In this case, a situation that an SCC is deactivated before a DL/UL HARQ process operating on the activated SCC is terminated may occur. Hence, it is necessary to have a method of processing a non-terminated HARQ process of an SCC (hereinafter (unended) SCC HARQp).

In order to solve the aforementioned problem, the present invention proposes a scheme of succeeding an unended SCC HARQp to a HARQ process of a specific CC (e.g., PCC/MCC). In this case, succeeding a CC #2 HARQp to a CC #1 HARQp means that a retransmission for the CC #2 HARQp is performed via DL/UL data transmission/reception using (on a CC #1) the CC #1 HARQp. A HARQp succession can be performed when a prescribed condition is satisfied only. The prescribed condition is exemplified in the following description.

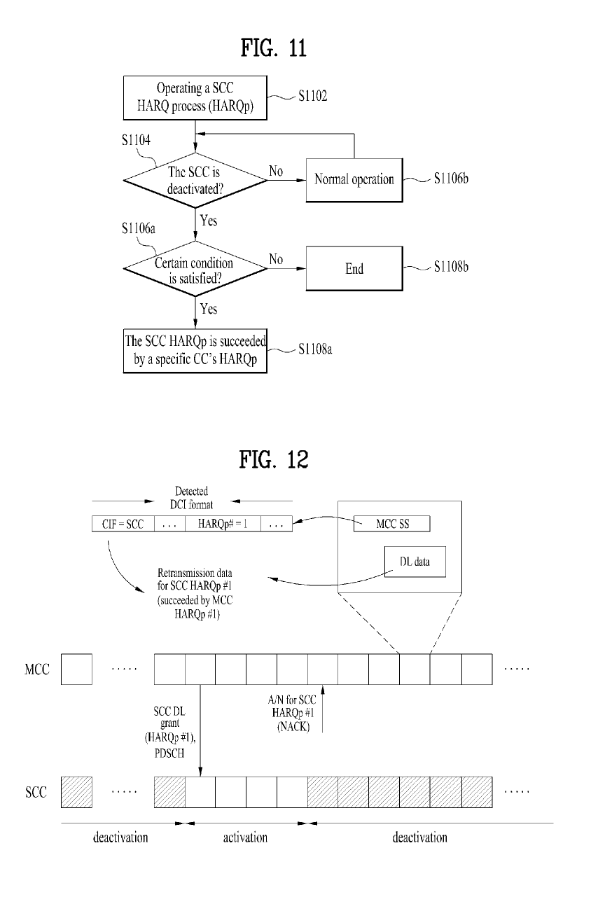

FIG. 11 is a diagram for an example of a HARQ process according to embodiment of the present invention. The present example assumes a CA situation that at least one MCC and at least one SCC are configured. And, assume that at least one specific SCC includes at least a part of a non-licensed band or a licensed band of a different system. The HARQ process of the present example corresponds to an example for the at least one specific SCC.

Referring to FIG. 11, base station/user equipment makes a HARQ process for a specific SCC (hereinafter SCC HARQp) operate/initiate [S1102]. Subsequently, the base station/user equipment checks whether the specific SCC is deactivated [1104]. The specific SCC can be automatically deactivated in prescribed time duration (e.g., less than 8 ms) after the specific SCC is activated, which is non-limited to this. Specifically, if DL/UL scheduling information includes information indicating SCC activation, the specific SCC is activated only for a predetermined time duration or a time duration given by an upper layer and may be then able to be automatically deactivated. As a different example, a deactivation timing point of the specific SCC can be explicitly indicated. For instance, a base station can include information (e.g., activation continuous time) on SCC deactivation in the DL/UL scheduling information. The information on the SCC deactivation can be included in the DL/UL scheduling information, only when a duration of a SCC corresponding to the W-zone is short (e.g., less than 8 ms) by performing a carrier-sensing or a database search. Meanwhile, in the present example, the information on the SCC activation and/or deactivation is used to determine whether to succeed a HARQp and can be replaced by information (e.g., HARQp succession indication information) related to a HARQp succession.

In case that the specific SCC is not deactivated, the base station/user equipment performs a normal operation performed in a state that the SCC is activated [S1106b]. Meanwhile, if the specific SCC is deactivated, the base station/user equipment determines whether a prescribed condition is satisfied [S1106a]. Although it is not limited to this, the prescribed condition includes whether an SCC HARQp is terminated on a timing point that the specific SCC is deactivated. In other word, the prescribed condition includes a case that the specific SCC is switched from an activated state to a deactivated state before the SCC HARQp is terminated. A different example of the prescribed condition is additionally provided in the following detailed example. If the prescribed condition (e.g., the SCC HARQp is not terminated on a timing point that the specific SCC is deactivated) is satisfied, the corresponding SCC HARQp is succeeded by a HARQp of a specific CC (e.g., PCC/MCC) [S1108a]. The specific CC succeeding the HARQp may correspond to the PCC/MCC or a specific CC different from the SCC). In the following description, for clarity, assume that the specific CC succeeding the HARQp corresponds to the MCC. For clarity, a linkage between the SCC HARQp and an MCC HARQp to which the SCC HARQp is succeeded (hereinafter (succeed) MCC HARQp) is defined as a HARQp linkage. A HARQp linkage configuration can be differently configured depending on a HARQ scheme (e.g., an asynchronous HARQ, a synchronous scheme). On the other hand, if the prescribed condition is not satisfied, the process according to the present example is terminated [S1108b].

In case of the asynchronous scheme, a HARQp linkage (i.e., the SCC HARQp numbered ‘x’ is succeeded to the MCC HARQp numbered ‘y’) can be configured between the HARQp number of an SCC and the HARQp number of an MCC. For instance, if it is assumed that the HARQp linkage is configured between an SCC HARQp #1 and an MCC HARQ #2, if the SCC HARQp #1 is not terminated on a timing point that the SCC is deactivated, the MCC HARQ #2 can retransmit data of the SCC HARQp #1 in a manner of inheriting (succeeding) the SCC HARQ #1. Hence, retransmission for the data of the SCC HARQp #1 and transmission of a signal related to the SCC HARQp #1 are performed on the MCC. Yet, if the MCC HARQp #2 is already assigned to schedule a MCC data, HARQp succession can be held until the corresponding MCC data scheduling is terminated. In other word, if the MCC data is not assigned to the succession MCC HARQp on the timing point that the SCC is deactivated, the HARQp succession can be immediately performed. If the MCC data is assigned to the succession MCC HARQp on the timing point that the SCC is deactivated, the HARQ succession can be performed after the HARQp for the corresponding data is terminated.

In case that the synchronous HARQ is used, a HARQp linkage can be configured between the (initial) SF number of the SCC HARQp and the (initial) SF number of the MCC HARQp. For instance, the SCC HARQp of which an initial grant/data transmission/reception is started in a SF #m can be succeeded to the MCC HARQp of which an initial grant/data transmission/reception is started in a SF #n. Yet, if the MCC HARQp #n is already assigned to schedule a MCC data, HARQp succession can be held until the corresponding MCC data scheduling is terminated. In other word, if the MCC data is not assigned to the succession MCC HARQp on the timing point that the SCC is deactivated, the HARQp succession can be immediately performed. If the MCC data is assigned to the succession MCC HARQp on the timing point that the SCC is deactivated, the HARQ succession can be immediately performed after the HARQp for the corresponding data is terminated.

In the following description, although it is assumed that an asynchronous HARQ scheme is used in DL and a synchronous HARQ scheme is used in UL, a DL/UL HARQ scheme is not limited to this.

In the following description, a method of configuring a HARQ linkage is explained.

Method 1: Pre-Configuration of HARQp Linkage

According to the present method, a HARQp linkage is configured in advance and the pre-configured HARQp linkage can be applied to a specific interval, preferably, the interval of which an SCC is deactivated. Although it is not limited to the following description, a base station can transmit HARQ linkage information to a user equipment via a broadcast signaling or an RRC (radio resource control) signaling/L1 (layer 1) signaling (e.g., PDCCH)/L2 signaling (e.g., MAC signaling). The HARQ linkage information can be transmitted on a PCC/MCC.

Method 2: Explicit Indication of Succession MCC HARQp

According to the present method, information on a succession MCC DL/UL HARQp can be directly signaled on a DL/UL grant PDCCH, which schedules an SCC DL/UL data. As one implementation example, a succession MCC DL HARQp number can be inserted to a DL grant (which schedules SCC DL data) in DL and an (initial) SF number corresponding to the succession MCC UL HARQp can be inserted to a UL grant (which schedules SCC UL data) in UL.

As a different implementation example, it is able to inform that which CC is in charge of carrying DL/UL data of an SCC in a manner of explicitly (or implicitly) adding 1-bit signal to PDCCH, which schedules the SCC. In particular, it is able to inform of whether PDSCH/PUSCH is transceived on the SCC or the MCC. In this case, although a user equipment is unable to exactly know whether the SCC is deactivated or not, it is able to inform the user equipment that which CC is in charge of transmitting/receiving the data (PDSCH/PUSCH) of the SCC.

Meanwhile, in case that a bandwidth of the MCC and a bandwidth of the SCC are different from each other, when the data of the SCC is scheduled on the MCC and the data of the SCC is scheduled on the SCC, a size of a resource allocation (e.g., resource block allocation) field necessary for scheduling the data of the SCC may be different from each other. It is because the size of the resource block allocation field is determined based on a bandwidth of DL/UL. Hence, following schemes may be considered.
Scheme 1: a resource allocation field of PDCCH, which schedules data of an SCC, is configured based on a maximum bandwidth among the MCC and the SCC. In this case, since the resource allocation field is configured based on the maximum bandwidth irrespective of whether the data of the SCC is transceived on the MCC or the SCC, it is operable without a scheduling restriction.
Scheme 2: a resource allocation field of PDCCH, which schedules data of an SCC, is configured based on a bandwidth of the SCC. If the bandwidth of the MCC is wider than the bandwidth of the SCC, PDSCH/PUSCH can be transceived by using a limited band only among a whole bandwidth of the MCC. If the bandwidth of the MCC is narrower than that of the SCC, a base station can schedule the data of the SCC in consideration of the bandwidth of the MCC.

Method 3: HARQp Linkage Configuration Based on HARQp Number/Timing

According to the present method, a HARQp linkage can be implicitly configured according to a HARQp number in a DL grant scheduling an SCC or a transmission/reception timing point of a UL grant/data. For instance, in case of DL, a DL HARQp of the MCC, which includes a HARQp number identical to that of a HARQp within the DL grant scheduling the SCC, can be automatically configured as a succession MCC DL HARQp. And, in case of UL, a UL HARQp of the MCC, which starts with an (initial) SF number identical to a reception timing point of an (initial) UL grant scheduling the SCC or a corresponding transmission timing point of a (initial) UL data, can be automatically configured as a succession MCC UL HARQp.

Method 4: HARQp Linkage Configuration Based on SCC CIF Detection

According to the present method, a corresponding (unended) SCC HARQp can be succeeded to a HARQp of a specific CC by receiving a DL/UL grant PDCCH including a CIF indicating an SCC in a specific interval, preferably, in an interval of which the SCC is deactivated (hereinafter SCC-CIF grant PDCCH or SCC-CIF grant) (The specific CC may correspond to a PCC/MCC or a specific SCC different from the SCC. For clarity, assume that the specific CC corresponds to the MCC).

The SCC-CIF grant can be detected via a PDCCH search space (simply, SS) of the corresponding SCC or the SS of the MCC only. In case that a cross-CC is configured, both the SCC SS and the MCC SS are configured on the MCC. The SS is a virtual resource region including a plurality of PDCCH candidates. A user equipment performs a blind decoding for a plurality of the PDCCH candidates within the SS to monitor PDCCH indicated to the user equipment. The blind decoding is performed based on a DCI format size. If the DCI format size is different, a separate blind decoding process is required. In order to detect the SCC-CIF grant via the SS of the corresponding SCC or the SS of the MCC, the SS of the corresponding SCC is also configured on the MCC in an interval of which the SCC is deactivated to make the user equipment perform a blind decoding for PDCCH. In this case, in order to reduce the number of performing the blind decoding, it may be preferable to identically match DL/UL DCI format size configured to schedule the SCC with the DL/UL DCI format size configured to schedule the MCC. Meanwhile, in order to detect the SCC-CIF grant via the SS of the MCC, a base station may not configure the SS on the MCC for a deactivated SCC and a user equipment may omit a blind decoding for PDCCH for the deactivated SCC.

For clarity, although it is assumed a case that the SCC-CIF grant is configured to be detected via the SS of the MCC only in the following description, it is also identically/similarly applicable to a case that the SCC-CIF grant is configured to be detected via the SS of the SCC or the SS of the MCC.

FIG. 12 is a diagram for an example of performing a HARQ process according to embodiment of the present invention. The present example exemplifies a DL HARQ process. According to the present example, if a DL grant including a CIF value of the deactivated SCC is received via the SS of the MCC, a user equipment can succeed an (unended) SCC DL HARQp corresponding to a HARQp number within the DL grant to an MCC DL HARQp, which is in a HARQp linkage relation (e.g., identical HARQp number). By doing so, a retransmission DL data of the succeeded DL HARQp is received on the MCC.

Referring to FIG. 12, a user equipment can receive an SCC DL grant and PDSCH from the MCC while the SCC is in an activated state. In this case, assume that the DL HARQp number within the SCC DL grant corresponds to 1. Subsequently, if PDSCH decoding fails, the user equipment transmits a NACK to a base station on a UL PCC. Since ACK/NACK is performed on the PCC, a HARQ process is not affected by activation/deactivation of the SCC. Yet, since the SCC is changed to a deactivated state before an SCC HARQp #1 is terminated, it is necessary to perform a HARQp succession to receive the SCC DL grant/PDSCH for a following retransmission. To this end, the user equipment attempts to detect the SCC-CIF grant in the SS of the MCC while the SCC is in the deactivated state. If a DL grant, which corresponds to a HARQp number #1 and includes a CIF value of the SCC, is received via the SS of the MCC (during the SCC deactivated interval), the base station/user equipment can perform a retransmission for an (unended) SCC DL HARQ #1 using an MCC DL HARQ #1, which is in a HARQp linkage relation. If the SCC-CIF grant is not detected, the SCC DL HARQp #1 is terminated as it is or the HARQ linkage relation predetermined according to the method 1 can be applied.

Meanwhile, if a plurality of SCC-CIF DL grants are detected, a firstly detected SCC-CIF DL grant in time can be used to sequentially succeed an (unended) SCC DL HARQp of a more preceding HARQp number. In this case, HARQ number of a succession MCC DL HARQp can be applied in a manner of being identical to the HARQp number within the SCC-CIF DL grant.

And, if a UL grant including a CIF value of a deactivated SCC is received via the SS of the MCC, an MCC UL HARQp, which starts on a reception timing point (e.g., SF) of the corresponding SCC-CIF UL grant or on a transmission timing (e.g., SF) of UL data corresponding to the SCC-CIF UL grant, can succeed an unended SCC UL HARQp. A retransmission UL data of the succeeded UL HARQp can be transmitted on the MCC. Meanwhile, if the unended SCC UL HARQp corresponds to plural numbers, a HARQp linkage can be configured between the HARQps where an (initial) SF number is identical to each other only. As a different scheme, if a plurality of the SCC-CIF UL grants are detected, a firstly detected SCC-CIF UL grant in time can be used to sequentially succeed the (unended) SCC UL HARQp of a more preceding (initial) SF number.

Method 5: HARQp Linkage Configuration Based on CC #2 CIF on CC #1 SS

According to the present method, a HARQp linkage can be configured between CCs in a manner of detecting a DL/UL grant (hereinafter CC #2-CIF grant) including a CIF, which indicates a different specific CC #2 via an SS of a specific CC #1. Although it is not limited to this, for instance, the CC #1 corresponds to the MCC and the CC #2 corresponds to the SCC, the CC #1 corresponds to the SCC and the CC #2 corresponds to the MCC, or the CC #1 corresponds to a specific SCC and the CC #2 corresponds to a further specific SCC. In this case, the SCC may be in a state of being activated or deactivated. The present method can be comprehended as a normalized form of the method 4. In particular, the present method can use a HARQp succession for not only a usage of a special CA situation of the method 4 (e.g., FIG. 10) but also a usage of UE load balancing between CCs, adaptation for a variable radio condition, and the like in a normal CA situation.

Specifically, if a DL grant including a CIF value of the CC #2 is received via the SS of the CC #1, a base station/user equipment can succeed a CC #2 DL HARQp including a HARQ number within the corresponding DL grant to a CC #1 DL HARQp, which is in a HARQp linkage relation (e.g., identical HARQ number). A retransmission DL data of the succeeded DL HARQp is received on the CC #1. If the SCC-CIF grant is not detected and the CC #2 is in an activated state, the CC #2 DL HARQp can be maintained as it is. And, if the SCC-CIF grant is not detected and the CC #2 is in a deactivated state, the CC #2 DL HARQp is terminated as it is or can be succeeded to a HARQp of a different specific CC according to the HARQ linkage relation predetermined according to the Method 1.

Meanwhile, if a plurality of the CC #2-CIF DL grants are detected, a firstly detected CC #2-CIF DL grant in time can be used to sequentially succeed a CC #2-CIF DL HARQp of a more preceding HARQp number. In this case, HARQ number of a succession CC #1 DL HARQp can be applied in a manner of being identical to the HARQp number within the CC #2-CIF DL grant.

And, if a UL grant including a CIF value of the CC #2 is received via the SS of the CC #1, a CC #1 UL HARQp, which starts on a reception timing point (e.g., SF) of the corresponding UL grant or on a transmission timing point (e.g., SF) of UL data, can succeed a CC #2 UL HARQp. A retransmission UL data of the succeeded UL HARQp can be transmitted on the CC #1. Meanwhile, if the CC #2 UL HARQp corresponds to plural numbers, a HARQp linkage can be configured between the HARQps where an (initial) SF number is identical to each other only. As a different scheme, if a plurality of the CC#2-CIF UL grants are detected, a firstly detected CC #2-CIF UL grant in time can be used to sequentially succeed an CC #2 UL HARQp of a more preceding (initial) SF number.

The aforementioned method 1 to 5 can consistently maintain the maximum number of a HARQp operating on a single CC. In a normal CA situation, if it is assumed that the maximum (DL or UL) number of the HARQp capable of operating in a single CC corresponds to M, the maximum number of a HARQ buffer capable of being assigned to a single CC may be less than M, preferably, identical to the M (assume that it is identical in the following description). In this case, the HARQ transmission/reception buffer i) may be shared between CCs or ii) can be individually assigned according to a CC. For instance, if it is assumed a case that two CCs (e.g., MCC and SCC) are aggregated, i) means a scheme that M number of HARQ buffer are assigned to the whole of the two CCs while the maximum M number of HARQp are operated for the whole of the two CCs. On the other hand, ii) means a scheme that the M number of HARQ buffer are assigned to each CC while the maximum M number of HARQp are operated for the whole of the two CCs.

Meanwhile, in case of the ii), since the (maximum) number of HARQp is less than the number of HARQ buffer, scheduling latency may increase and it may cause a significant problem in a situation that constant activation for an SCC is not secured. Hence, it is able to consider a method of moving a CC, which performs transmission/reception of DL or UL data assigned to HARQp of the SCC and a HARQ buffer, not to the corresponding SCC but to a specific CC or the MCC while the maximum number of HARQp (for DL or UL) and the maximum number of HARQ buffer according to a CC are maintained to M, and M, respectively (i.e., changing of a CC transmitting/receiving data). Based on this, the method 4 and 5 can be modified as follows.

Method 4-1: HARQ Linkage Configuration Based on SCC CIF Detection

According to the present method, DL/UL data, which is assigned to a corresponding (unended) SCC HARQp, transmission/reception can be performed via (not a corresponding SCC but) a specific CC by receiving a DL/UL grant PDCCH (hereinafter SCC-CIF grant PDCCH or SCC-CIF grant) including a CIF indicating the SCC in a specific interval, preferably, in an interval of which the SCC is deactivated. The specific CC may correspond to an MCC or a specific SCC different from the SCC. For clarity, assume that the specific CC corresponds to the MCC.

The SCC-CIF grant can be detected via an SS of the corresponding SCC or the SS of the MCC only. In order to detect the SCC-CIF grant via the SS of the corresponding SCC or the SS of the MCC, the SS of the corresponding SCC is also configured on the MCC in an interval of which the SCC is deactivated to make the user equipment perform a blind decoding for PDCCH. In this case, in order to reduce the number of performing the blind decoding, it may be preferable to identically match DL/UL DCI format size configured to schedule the SCC with the DL/UL DCI format size configured to schedule the MCC. Meanwhile, in order to detect the SCC-CIF grant via the SS of the MCC only, a base station may not configure the SS on the MCC for the deactivated SCC and a user equipment may omit a blind decoding for PDCCH for the deactivated SCC.

For clarity, although it is assumed a case that the SCC-CIF grant is configured to be detected via the SS of the MCC only in the following description, it is also identically/similarly applicable to a case that the SCC-CIF grant is configured to be detected via the SS of the SCC or the SS of the MCC.

Specifically, if a DL grant including a CIF value of the deactivated SCC is received via the SS of the MCC, DL data (and/or retransmission data for the DL data) assigned to (unended) SCC DL HARQp, which includes HARQp number within the corresponding DL grant, can be received via the MCC. DL grant including the CIF value of the SCC and the DL data including the CIF value of the MCC can be simultaneously received via the SS of the MCC (in this case, the HARQ numbers within the corresponding DL grant may be identical to each other or different from each other). Preferably, the DL grant capable of being transmitted via the SS of the MCC in a subframe may be limited to one per CC (CIF). If a UL grant including a CIF value of the deactivated SCC is received via the SS of the MCC, UL data (and/or retransmission data corresponding to the UL data) assigned to an (unended) SCC UL HARQp can be transmitted on a corresponding UL grant reception timing point (e.g., SF) or on a corresponding UL data transmission timing point (e.g., SF) via the MCC. UL grant including a CIF value of the SCC and UL grant including a CIF value of the MCC can be simultaneously received via the SS of the MCC. Preferably, the UL grant capable of being transmitted via the SS of the MCC in a subframe can be limited to one per CC (CIF).

Method 5-1: HARQp Linkage Configuration Based on CC #2 CIF on CC #1 SS

According to the present method, a HARQp linkage can be configured between CCs in a manner of detecting a DL/UL grant (hereinafter CC #2-CIF grant) including a CIF, which indicates a different specific CC #2 via an SS of a CC #1. Although it is not limited to this, for instance, the CC #1 corresponds to the MCC and the CC #2 corresponds to the SCC, the CC #1 corresponds to the SCC and the CC #2 corresponds to the MCC, or the CC #1 corresponds to a specific SCC and the CC #2 corresponds to a further specific SCC. In this case, the SCC may be in a state of being inactivated or deactivated. A CC group consisted of at least one CC(s) and a CC group consisted of at least one CC(s) may be in the CC #1-CC #2 relation. And, configuration of the CC #1-CC #2 relation can be signaled by a base station. The present method can be used for not only a usage of a special CA situation of the method 4-1 but also a usage of UE load balancing between CCs, adaptation for a variable radio condition, and the like in a normal CA situation. In particular, the present method can use a HARQp succession for not only a usage of a special CA situation of the method 4-1 but also a usage of UE load balancing between CCs, adaptation for a variable radio condition, and the like in a normal CA situation.

Specifically, if a DL grant including a CIF value of the CC #2 is received via the SS of the CC #1, a base station/user equipment can receive DL data (and/or retransmission data corresponding to the DL data), which is assigned to a CC #2 DL HARQp including HARQp number within the corresponding DL grant, via the CC #1. DL grant including a CIF value of the CC #2 and DL grant including a CIF value of the CC #1 can be simultaneously received via the SS of the CC #1 (in this case, the HARQp numbers within the corresponding DL grant may be identical to each other or may be different from each other). Preferably, the DL grant capable of being transmitted via the SS of the CC #1 in one subframe can be limited to one per CC (CIF). And, if UL grant including a CIF value of the CC #2 is received via the SS of the CC #1, UL data (and/or retransmission data corresponding to the UL data) assigned to the CC #2 UL HARQp can be transmitted on UL grant reception timing point (e.g., SF) or UL data transmission timing point (e.g., SF) corresponding to the reception timing point via the MCC. The UL grant including the CIF value of the CC #2 and the UL grant including the CIF value of the CC #1 can be simultaneously received via the SS of the CC #1. Preferably, the UL grant capable of being transmitted via the SS of the CC #1 in one subframe can be limited to one per CC (CIF).

Meanwhile, in the proposed method (in particular, 5 and 5-1), if both a DCI format scheduling the CC #1 (hereinafter DCI-1) and a DCI format scheduling the CC #2 (hereinafter DCI-2) are identical to each other in size and include an identical RNTI when a cross-CC scheduling is performed, the DCI-1 and the DCI-2 can share an SS (SS sharing). In particular, if the SS for the DCI-1 and the SS for the DCI-2 are called an SS-1 and an SS-2, respectively, the DCI-1 and the DCI-2 can be transmitted via both the SS-1 and the SS-2. By doing so, chance of PDCCH blocking can be reduced and the (maximum) number of a blind decoding may not be increased. Yet, if the SS sharing is permitted to the proposed methods, there may exist ambiguity between a user equipment and a base station when HARQp succession (in Method 5) or modification of a data transmission/reception CC (in Method 5-1) is applied. For instance, although the base station transmits the DCI-2 via the SS-1 to modify a data transmission/reception CC (in particular, the data transmission/reception CC assigned to the CC #2 HARQp is modified to CC #1), the user equipment may differently recognize it as the DCI-2 is transmitted via the SS-1 simply by the SS sharing (in particular, the data transmission/reception CC assigned to the CC #2 HARQp still corresponds to the CC #2 and the SS is simply borrowed). And, an opposite case may occur as well. Hence, regarding both the CC #1 and the CC #2 related to HARQp succession, in order to get rid of ambiguity capable of being occurred by an SS sharing operation, it is able to consider methods as follow.
Whether the SS sharing operation between the DCI-1 and the DCI-2 is permitted can be configured via an RRC signaling and the like. If the SS sharing is configured not to be permitted, the SS sharing is permitted only in a region in which the SS-1 and the SS-2 are overlapped with each other. In this case, a HARQp succession or data transmission/reception CC modification may not permitted in the corresponding region. The HARQp succession or the data transmission/reception CC modification can be permitted in an SS-1 region only, which is not overlapped with an SS-2. In this case, the SS sharing may not be permitted in the corresponding region.
An X-bit padding can be applied to intentionally differentiate a size of the DCI-1 and that of the DCI-2 (e.g., X=1). Whether the X-bit padding is applied and which DCI format is applied by the X-bit padding can be configured via an RRC signaling and the like.

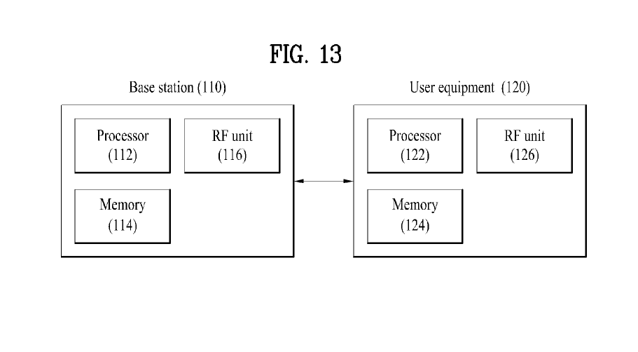

FIG. 13 is a diagram for an example of a base station and a user equipment applicable to one embodiment of the present invention. If a relay is included in a wireless communication system, a communication in backhaul link is performed between a base station and the relay and a communication in access link is performed between the relay and a user equipment. Hence, either the base station or the user equipment in the drawing can be replaced with the relay in accordance with a situation.

Referring to FIG. 13, a wireless communication system includes a base station 110 and a user equipment 120. The base station 110 includes a processor 112, a memory 114, and a RF (radio frequency) unit 116. The processor 112 is configured to implement a procedure and/or methods proposed by the present invention. The memory 114 is connected with the processor 112 and stores various informations to drive the processor 112. The RF unit 116 is connected with the processor 112 and is configured to transmit/receive a radio signal. The user equipment 120 includes a processor 122, a memory 124, and a RF (radio frequency) unit 126. The processor 122 is configured to implement a procedure and/or methods proposed by the present invention. The memory 124 is connected with the processor 122 and stores various informations to drive the processor 122. The RF unit 126 is connected with the processor 122 and is configured to transmit/receive a radio signal. The base station 110 and/or the user equipment 120 may have a single antenna or multiple antennas.

The above-mentioned embodiments correspond to combinations of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

In this disclosure, embodiments of the present invention are mainly explained centering on a data transmission and reception between a user equipment and a base station. A specific operation explained as performed by a base station may be performed by an upper node of the base station in some cases. In particular, in a network constructed with a plurality of network nodes including a base station, it is apparent that various operations performed for communication with a user equipment can be performed by the base station or other networks except the base station. ‘Base station (BS)’ may be substituted with such a terminology as a fixed station, a Node B, an eNode B (eNB), an access point (AP) and the like. And, a terminal may be substituted with such a terminology as a user equipment (UE), a mobile station (MS), a mobile station subscriber station (MSS), and the like.

Embodiments of the present invention can be implemented using various means. For instance, embodiments of the present invention can be implemented using hardware, firmware, software and/or any combinations thereof. In the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the various means known in public.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

The present invention can be used for such a wireless communication device as a user equipment, a relay, a base station, and the like.

What is claimed is:

1. A method of performing a HARQ (hybrid automatic repeat request) process by a user equipment configured of a plurality of cells in a wireless communication system, the method comprising:
receiving scheduling information to transmit data in a first cell;
operating a first HARQ process in the first cell based on the scheduling information; and
if a prescribed condition is satisfied, succeeding an operation of the first HARQ process to a second HARQ process of a second cell different from the first cell.

2. The method of claim 1, wherein the prescribed condition comprises a conversion of the first cell converted from an activated state to a deactivated state before the first HARQ process is terminated.

3. The method of claim 1, wherein the prescribed condition comprises reception of a DCI (downlink control information) format containing carrier indication information indicating the first cell when the first cell is in a deactivated state.

4. The method of claim 3, wherein the DCI format is received via a third cell different from the first cell and detected in a PDCCH (physical downlink control channel) search space for the third cell in a subframe of the third cell.

5. The method of claim 3, wherein a second HARQ process of the second cell is determined based on HARQ process number indication information in the DCI format.

6. The method of claim 3, wherein a second HARQ process of the second cell is determined based on a subframe of which the DCI format is received.

7. A user equipment of performing a HARQ (hybrid automatic repeat request) process in a state of configuring a plurality of cells in a wireless communication system, the user equipment comprising:
a radio frequency (RF) unit; and
a processor,
the processor configured to receive scheduling information to transmit data in a first cell, the processor configured to operate a first HARQ process in the first cell based on the scheduling information, if a prescribed condition is satisfied, the processor configured to succeed an operation of the first HARQ process to a second HARQ process of a second cell different from the first cell.

8. The user equipment of claim 7, wherein the prescribed condition comprises a conversion of the first cell converted from an activated state to a deactivated state before the first HARQ process is terminated.

9. The user equipment of claim 7, wherein the prescribed condition comprises reception of a DCI (downlink control information) format containing carrier indication information indicating the first cell when the first cell is in a deactivated state.

10. The user equipment of claim 9, wherein the DCI format is received via a third cell different from the first cell and detected in a PDCCH (physical downlink control channel) search space for the third cell in a subframe of the third cell.

11. The user equipment of claim 9, wherein a second HARQ process of the second cell is determined based on HARQ process number indication information in the DCI format.

12. The user equipment of claim 9, wherein a second HARQ process of the second cell is determined based on a subframe of which the DCI format is received.
